(19) United States
(12) Patent Application Publication
(10) Pub. No.: US 2024/0052992 A1
(43) Pub. Date: Feb. 15, 2024

(54) Collapsible Light Fixtures With Pliable Diffuser And Reflector

(71) Applicant: ABL IP Holding LLC, Atlanta, GA (US)

(72) Inventors: Ryan Matthew Walker, Colorado Springs, CO (US); Christopher Jay Sorensen, Arvada, CO (US); Carl T. Gould, Golden, CO (US); Zachary Adam Ingalls, Littleton, CO (US); Dominic Matthew Large, Broomfield, CO (US); Dirk Zylstra, Montreal (CA); Alexis Rondeau, Montreal (CA)

(21) Appl. No.: 17/885,927

(22) Filed: Aug. 11, 2022

(51) Int. Cl. F21V 3/02; F21V 7/00; F21S 8/06

(52) U.S. Cl. CPC F21V 3/02; F21V 7/005; F21S 8/061

(57) ABSTRACT

A light fixture includes an optics assembly, a frame assembly, a reflector, and a diffuser. The optics assembly includes at least one light source for emitting light in a first direction. The diffuser is formed from a pliable material. The frame assembly is adapted to support the reflector and the diffuser relative to the optics assembly such that the reflector reflects light emitted by the at least one light source toward the diffuser.

### FIELD OF THE INVENTION

This application relates to light fixtures, and more particularly to collapsible light fixtures.

### BACKGROUND

Light fixtures may be suspended below a ceiling to illuminate an area below. Traditional light fixtures may be large in profile and require more materials to construct, and such larger fixtures typically require a larger luminous surface or lensing to provide the desired lumen output. Alternatively, traditional light fixtures may be smaller in profile and therefore use less materials, but such light fixtures have smaller luminous surfaces that must have a higher degree of brightness to emit an equivalent lumen output, which can result in glare and discomfort to the occupants of a space. Traditional light fixtures for ceilings are also large and have a substantial shipping impact, resulting in higher costs and carbon emissions.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a light fixture includes a collapsible frame assembly, an optics assembly with a light source, a pliable reflector, and a pliable diffuser. In some embodiments, the pliable reflector may be a fabric reflector and the pliable diffuser may be a fabric diffuser. The fabric reflector may be attached to the collapsible frame assembly and extend above the optics assembly, and the fabric diffuser may be attached to the collapsible frame assembly and extend below the optics assembly. The fabric reflector may include a patterned region of perforations that allow some emitted light to pass upwardly through the reflector while other of the light passes downwardly out of the fixture through the diffuser. In this way, the light fixture provides both uplighting and downlighting.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 is a lower perspective view of a light fixture according to embodiments.

FIG. 2 is an upper perspective view of the light fixture of FIG. 1.

FIG. 3 is an end view of the light fixture of FIG. 1.

FIG. 4 is a top view of the light fixture of FIG. 1.

FIG. 5 illustrates a portion of a frame assembly of the light fixture of FIG. 1.

FIG. 6 is an end view of a portion of the light fixture of FIG. 1.

FIG. 7 is a perspective, sectional view of a portion of the light fixture of FIG. 1.

FIG. 8 is a perspective view of a support of a frame assembly of the light fixture of FIG. 1.

FIG. 9 is a perspective view of a rail end cap of the frame assembly of the light fixture of FIG. 1.

FIG. 9A is an enlarged view of a portion of the rail end cap of FIG. 9.

FIG. 10 is a perspective view of a portion of the light fixture with the rail end cap and an optic end cap removed.

FIG. 11 illustrates a portion of a patterned region of a reflector of a light fixture according to embodiments.

FIG. 12 illustrates a portion of a patterned region of a reflector of a light fixture according to embodiments.

FIGS. 13A-D illustrate steps for assembling a light fixture according to embodiments.

FIG. 14 is a luminous intensity polar plot of light distribution from a light fixture according to embodiments.

FIG. 15 illustrates a light fixture according to embodiments in a collapsed configuration.

FIG. 16 illustrates a light fixture according to embodiments.

### DETAILED DESCRIPTION

Described herein are light fixtures that may be suspended from a ceiling system. The light fixtures described herein may be movable between a collapsed configuration and an expanded configuration, which may allow the light fixtures to be shipped or otherwise handled while having a reduced form. The light fixtures described herein may be movable between the collapsed configuration and the expanded configuration (or vice versa) without requiring tools. In some embodiments, the light fixtures include a fabric reflector and/or a fabric diffuser, which may provide cost and weight savings while facilitating movement between the collapsed configuration and the expanded configuration. In various embodiments, the light fixtures described herein use less materials compared to a traditional light fixture of a similar size. Light fixtures described herein may provide improved light distribution both above and below the light fixture. In certain embodiments, a ratio of indirect light to direct light is controlled via a patterned area in the fabric reflector to provide the improved light distribution. Various other benefits and advantages may be realized with the systems and methods provided herein, and the aforementioned advantages should not be considered limiting.

In the following description, positional terms like “above,” “below,” “vertical,” “horizontal,” “bottom,” “top,” and the like are sometimes used to aid in explaining and specifying features illustrated in the drawings as presented, that is, in the orientation in which labels of the drawings read normally. These meanings are adhered to, notwithstanding that the luminaires herein may be mounted to surfaces that are not horizontal. When light is said to be emitted “downwardly” at least most of such light is emitted across one or more angles that are below horizontal when a luminaire is oriented as shown in the drawings; such angles include nadir, but are not limited to nadir. Similarly, when light is said to be emitted “upwardly” at least most of such light is emitted across one or more angles that are above horizontal when a luminaire is oriented as shown in the drawings; such angles include zenith, but are not limited to zenith.

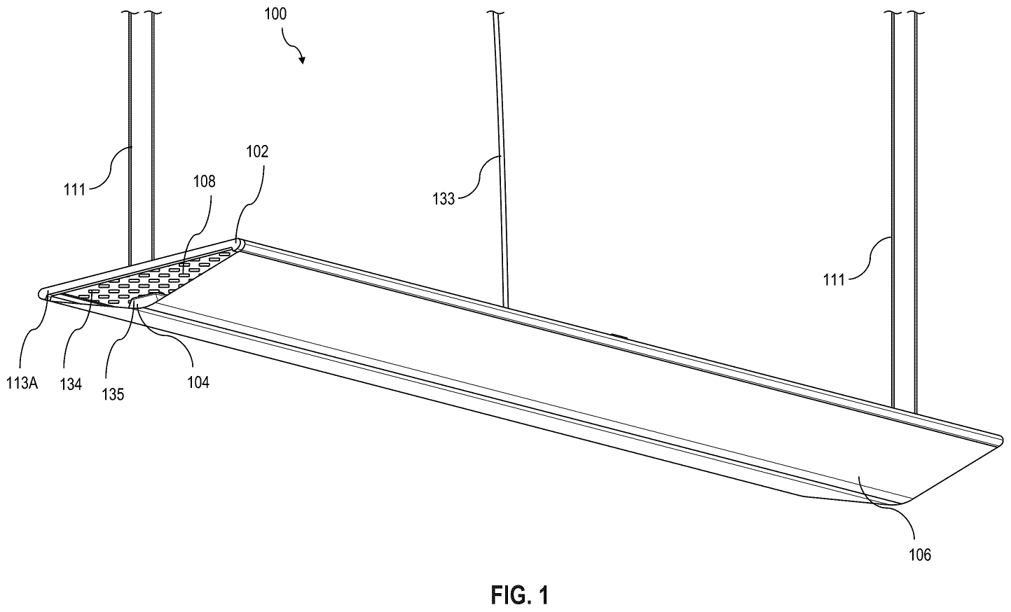

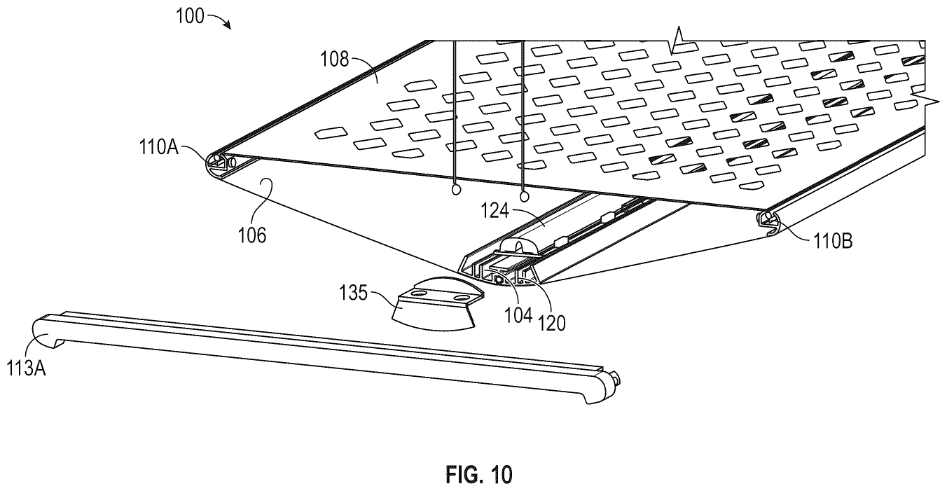

FIGS. 1-10 illustrate a light fixture 100 according to embodiments. The light fixture 100 generally includes a frame assembly 102, an optics assembly 104, a diffuser 106, and a reflector 108. Suspension mechanisms 111 such as rods, cables, etc. may be used to suspend the light fixture 100 from a support structure such as a ceiling. In some embodiments, wiring or cabling 133 for power, data communication, etc. may be provided to the light fixture 100.

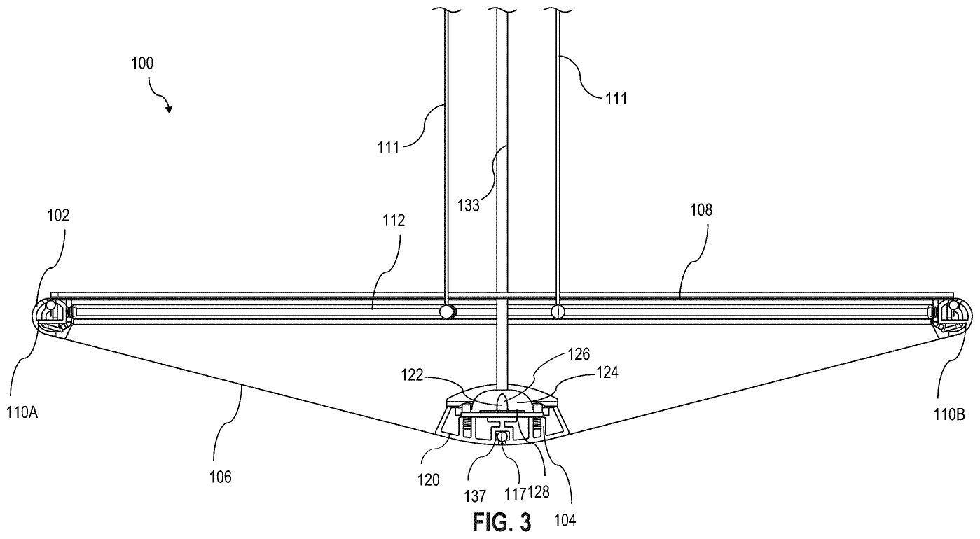

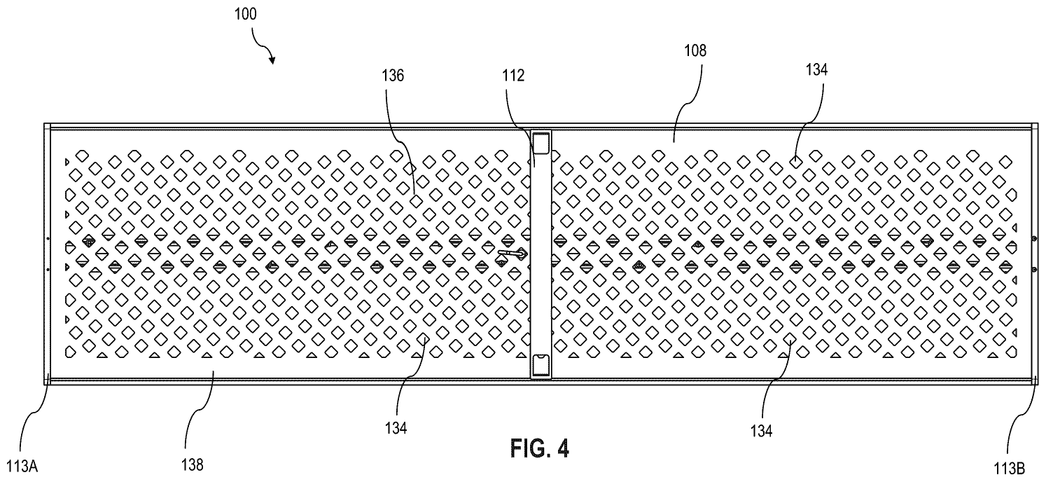

The frame assembly 102 includes longitudinal rails 110A-B (see FIG. 3), one or more lateral supports 112 extending between the rails 110A-B (see FIG. 4), and rail end caps 113A-B provided at the ends of the rails 110A-B and extending between the rails 110A-B. The rails 110A-B, supports 112, and rail end caps 113A-B may be formed of any material having sufficient structural integrity and rigidity. Suitable materials include, but are not limited to, polymeric or metallic (e.g., steel, aluminum, etc.) materials. The rails 110A-B, supports 112, and rail end caps 113A-B may be formed using various methods, including, but not limited to, molding, extruding, casting, etc. In some embodiments, the rails 110A-B are formed from extruded aluminum. The rails 110A-B, supports 112, and rail end caps 113A-B may be formed of any length/width/geometry depending on the desired scale (i.e., length and width) and geometry of the light fixture 100.

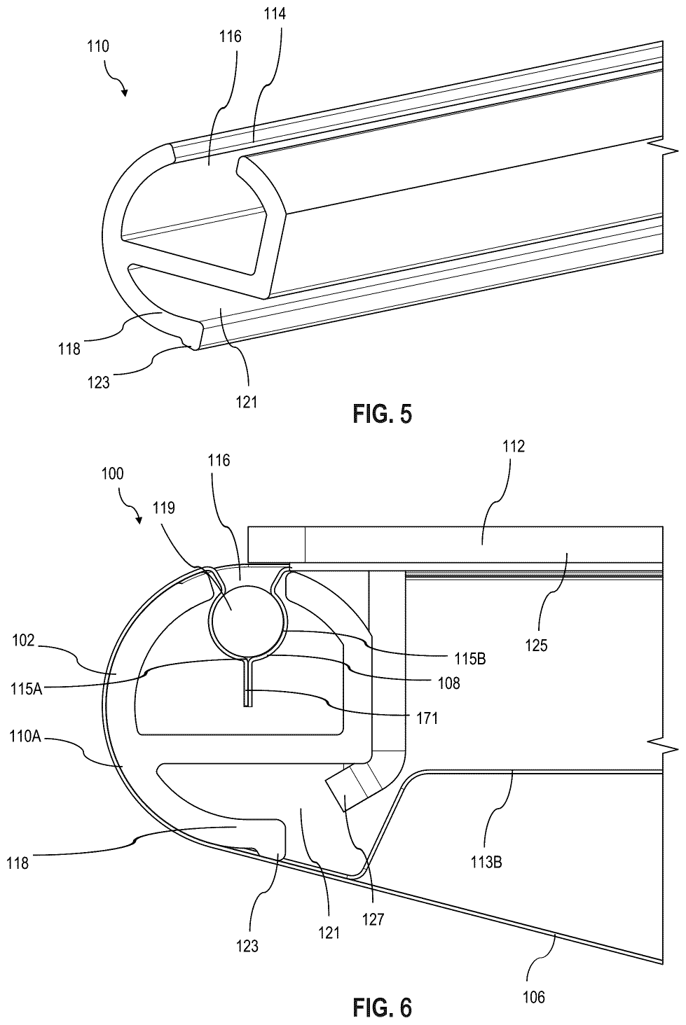

Referring to FIG. 5, each rail 110A-B may include an engagement feature 114 for engaging the diffuser 106 and/or the reflector 108. In the embodiment illustrated, the engagement feature 114 is a channel 116 that at least partially receives at least a portion of the diffuser 106 and/or the reflector 108. In some embodiments, respective edge portions 115A, 115B of the diffuser 106 and reflector 108 are joined together via sewing, etc., although other engagement features 114 may be used as desired. As illustrated in FIG. 6, in certain embodiments, the edge portions 115A, 115B are retained within the channel 116 via a retention member such as but not limited to a retention rod 119. In this example, the retention rod 119 has a diameter greater than a width of the opening of the channel 116. Thus, once the edge portions 115A, 115B are positioned within the channel 116 and the retention rod 119 slid into place, the edge portions 115A, 115B cannot back out of the channel 116. Retention of the edge portions 115A, 115B within the channel 116 may secure the diffuser 106 and/or reflector 108 relative to the rail 110 and may also tension the diffuser 106 and reflector 108 in the expanded configuration.

In certain embodiments, the rails 110A-B also include a lower portion 118. The lower portion 118 may define a lower channel 121, and as illustrated in FIG. 6, a support leg 127 of the support 112 may engage and/or be at least partially received within the lower channel 121 to facilitate positioning and retention of the support 112 relative to the rail 110. In some embodiments, the lower portion 118 includes a rib 123 that contacts the diffuser 106. When included, the rib 123 may further position the diffuser 106 relative to the rail 110 to shape and/or provide tension to the diffuser 106 in the expanded configuration.

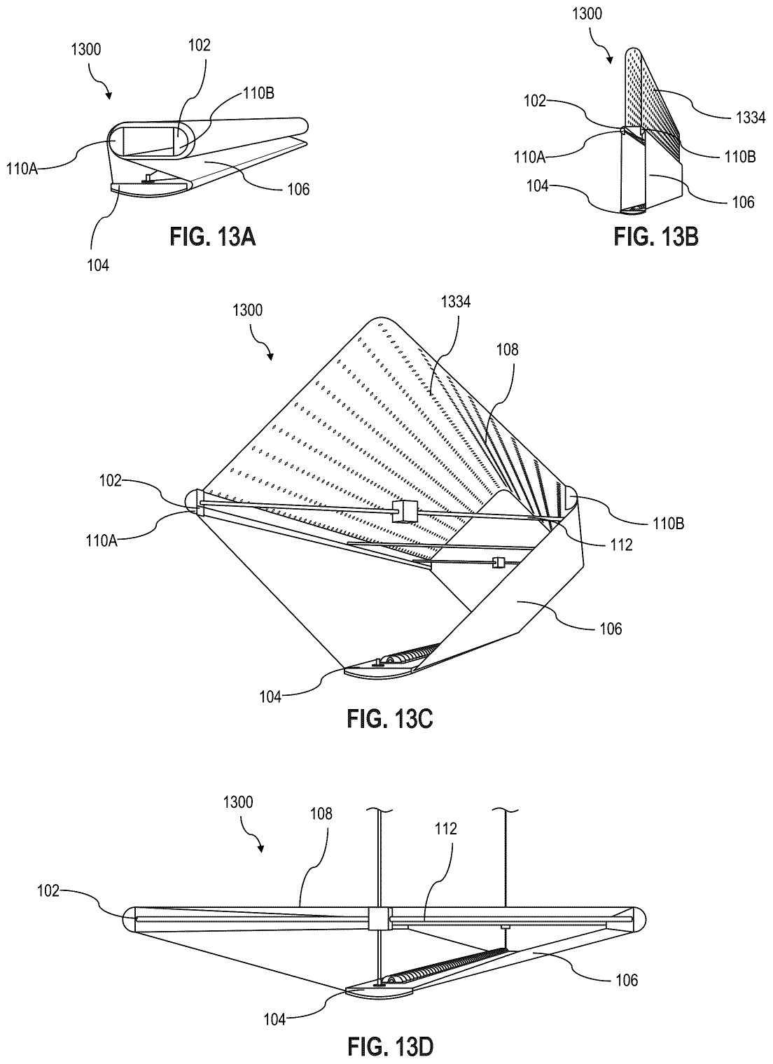

The rails 110A-B are movable between a collapsed configuration (see FIGS. 13A-B) and an expanded configuration (see FIGS. 1-4 and 13D). In various embodiments, the supports 112 and/or the rail end caps 113A-B may engage the rails 110A-B in the expanded configuration for maintaining the relative positioning of the rails 110A-B. In such embodiments, the supports 112 and the rail end caps 113A-B may hold the shape of the light fixture 100 in place in the expanded configuration. Any number of supports 112 may be used, and the supports 112 may be provided internally within the light fixture 100 or externally on the light fixture 100. For example, in the embodiment of FIGS. 1-4, the support 112 is externally positioned on the light fixture 100. In contrast and with reference to FIG. 13C, the supports 12 are internal rods that slidingly engage the lower channel 121 of rails 110A-B to permit collapse of the light fixture for shipment and storage and to permit expansion and retention of the light fixture 100 in an assembled state for use.

In certain embodiments, the supports 112 are connected to, or at least otherwise positioned relative to, the rails 110A-B at least while the rails are in the expanded configuration for maintaining the relative positioning of the rails 110A-B. In other embodiments, the supports 112 are connected to the rails 110A-B in both the expanded configuration and the collapsed configuration, and the supports 112 may facilitate movement between the two positions. As non-limiting examples, the supports 112 may be connected to the rails 110A-B via hinge mechanisms, pivot joints, sliding mechanisms, and/or as otherwise desired such that the rails 110A-B are movable between the expanded configuration and the collapsed configuration while connected to the supports 112. As an example, the supports 112 may be retained within and translate along the lower channels 121 and/or other channels of the rails 110A-B as the rails 110A-B are moved between the expanded configuration and the collapsed configuration, as shown in FIGS. 13C and 13D. In the embodiment of FIGS. 1-10, the supports 112 and the rail end caps 113A-B engage the rails 110A-B in the expanded configuration and are detachable from the rails 110A-B such that the rails 110A-B may be moved to the collapsed configuration.

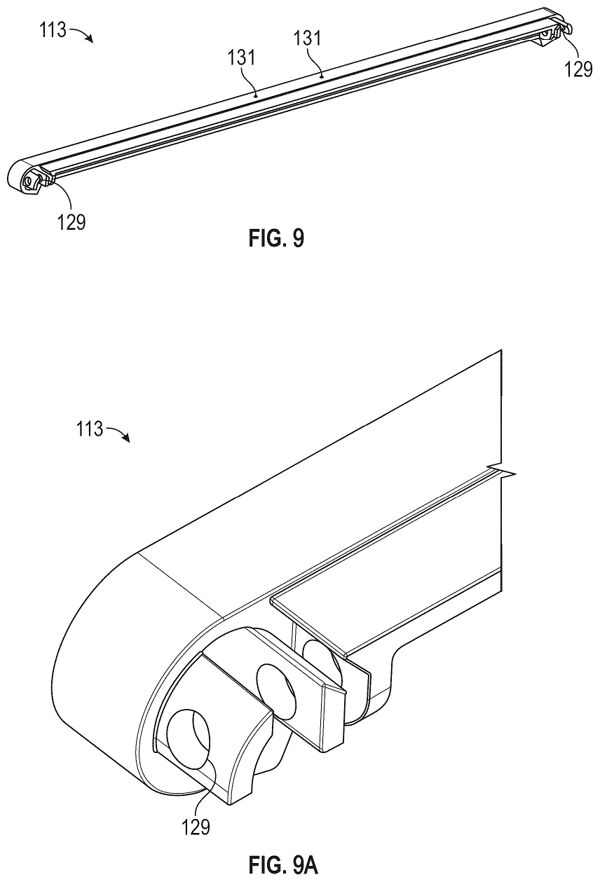

Referring to FIG. 8, in some embodiments, the support 112 includes a support body 125 with support legs 127 from the support body 125. In some embodiments, the support legs 127 engaging the rails 110A-B, such as for example, via a snap-fit engagement. In such embodiments, the support legs 127 may extend through the reflector 108 and along/around a rail 110A-B to engage and/or be at least partially received within the lower channels 121 of the rails 110A-B. Referring to FIGS. 9 and 9A, in various embodiments, the rail end caps 113 include one or more projections 129 that are positionable within the channels 116 at opposing ends of the light fixture 100. FIG. 9 also illustrates apertures 131 that may be used to engage the suspension mechanisms 111, although in other embodiments the rail end caps 113 may include other engagement features as desired for engaging the suspension mechanisms 111.

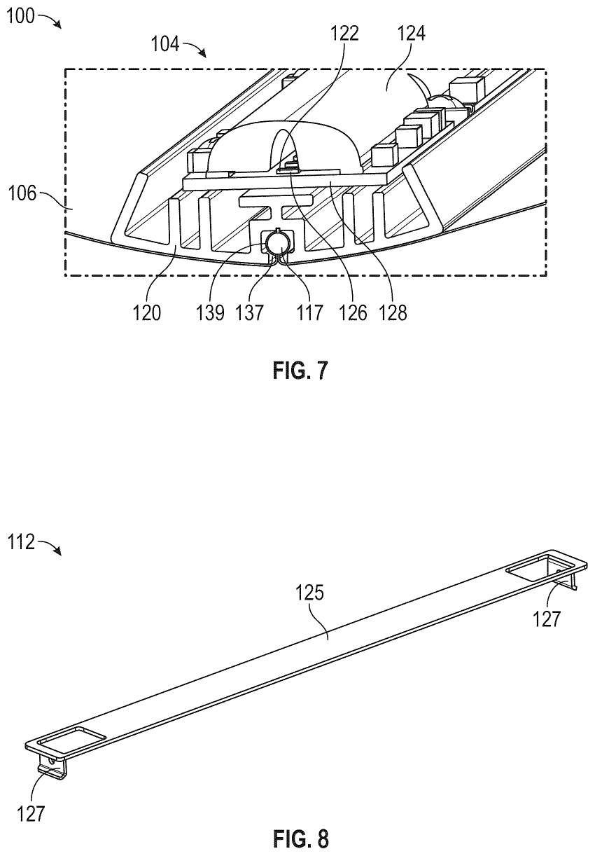

Referring to FIGS. 3 and 7, the optics assembly 104 generally includes a support member 120, one or more light sources 122, a lens 124 positioned over the one or more light sources 122, and opposing ends caps 135. In certain embodiments, the support member 120 is indirectly connected to the rails 110A-B via the diffuser 106. The support member 120 may have various dimensions, shapes and/or profiles as desired, and the support member 120 illustrated should not be considered limiting on the disclosure. In some embodiments, the support member 120 includes a channel 137, and at least a portion 139 of the diffuser 106 may be positioned within the channel 137. In the embodiment illustrated, a retention member, such as but not limited to, a retention rod 117 may retain the portion 139 of the diffuser 106 within the channel 137. In this example, the retention rod 117 has a diameter greater than a width of the opening of the channel 137 and may retain the portion 139 of the diffuser 106 within the channel 137. In some embodiments, the diffuser 106 extends at least partially around the retention rod 117. Retention of the portion 139 of the diffuser 106 within the channel 137 may secure the diffuser 106 relative to the optics assembly 104 and may also tension the diffuser 106 in the expanded configuration.

In various embodiments, a weight of the support member 120 may anchor and/or facilitate maintaining of a shape of the light fixture 100 when the light fixture 100 is in the expanded configuration. The support member 120 may be formed of any material having suitable structural integrity and/or thermal management properties. Suitable materials may include, but are not limited to, polymeric or metallic (e.g., steel, aluminum, etc.) materials. The support member 120 may be formed using various methods, including, but not limited to, molding, extruding, casting, etc. In some embodiments, the support member 120 is formed from extruded aluminum.

The one or more light sources 122 may include any suitable source of light, including but not limited to a light emitting diode (LED) 126, an organic LED (OLED), an incandescent bulb, combinations thereof, or other sources as desired. In various embodiments, the LEDs 126 are provided on a printed circuit board (PCB) 128, and the PCB 128 is supported on the support member 120. Any number of LEDs 126 may be provided on the PCB 128, and when a plurality of LEDs 126 are included, the LEDs 126 may be provided in various numbers, patterns, and/or arrangements on the PCB 128 as desired. The lens 124 may be constructed from various materials as desired to control the output distribution of light emitted from the light sources 122, and as illustrated in FIG. 3, the lens 124 may extend generally over the one or more light sources 122.

In various embodiments, the diffuser 106 may be formed from any material that diffusely transmits light. In some embodiments, it is desirable that the material have a light transmission rate of at least 60%, at least 65%, at least 70%, at least 75%, at least 80%, at least 85%, at least 90%, and/or at least 95%. While the diffuser 106 may be formed of rigid materials, in some embodiments the diffuser 106 is formed of a pliable material that permits the diffuser 106 to be folded, wrapped or otherwise collapsed such that the footprint of the light fixture 100 may be reduced when the light fixture 100 is in an un-installed state. The diffuser 106 may be formed from any flexible or pliable material that diffuses light, such as, but not limited to, fabric materials, thin polymeric materials, and/or paper materials. In some embodiments, the diffuser 106 is formed of a fabric material having relatively high light transmissivity and relatively low reflectivity. Suitable fabrics include, but are not limited to, nonwoven polypropylene (PP). While the fabric may have any fiber density, fabrics having fiber densities between 60 to 100 grams per square meter (GSM) may be suitable for some applications. In some embodiments, the material of the diffuser 106 is constructed from a recycled material. In various embodiments, the light fixture 100 with the diffuser 106 provides a uniform luminance across a bottom of the light fixture 100.

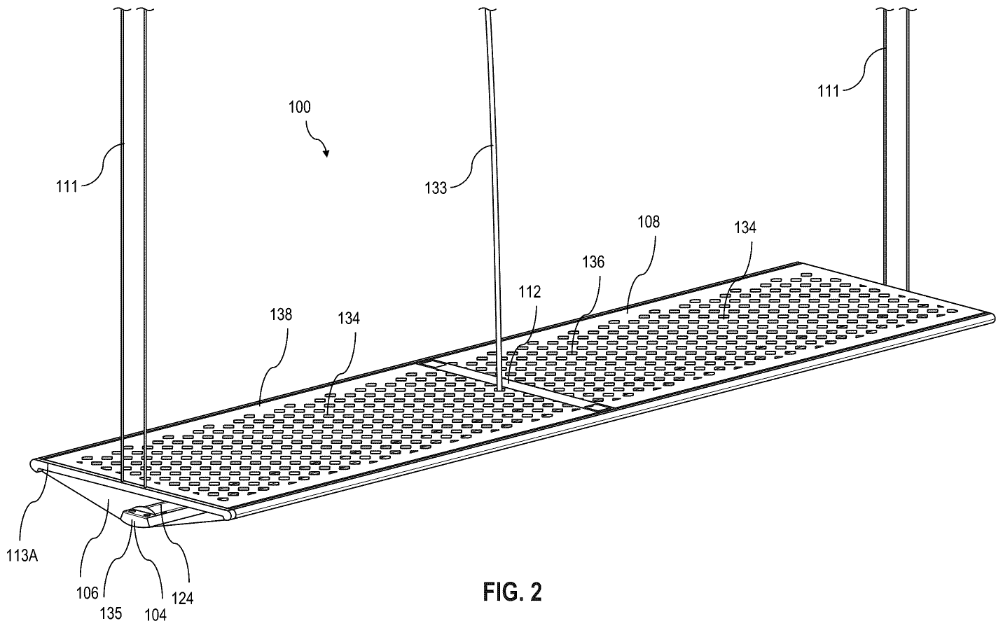

The diffuser 106 of the light fixture 100 extends from the rails 110A-B to the optics assembly 104, and in certain embodiments the diffuser 106 is connected to the rails 110A-B by positioning opposing edge portions 115A within the channels 116. In various embodiments, the diffuser 106 allows for the light fixture 100 to be moved between the expanded configuration and the collapsed configuration while the diffuser 106 is connected to the rails 110A-B. In certain embodiments, the diffuser 106 extends below and/or at least partially along the lower surface of the support member 120 of the optics assembly 104 in the expanded configuration, although it need not in other embodiments. In various embodiments, the portion 139 of the diffuser 106 is positioned within the channel 137 of the optics assembly 104. Similarly, in some embodiments, the diffuser 106 may at least partially wrap around the rails 110A-B of the frame assembly 102. The rails 110A-B in the expanded configuration together with the support member 120 of the optics assembly 104 may shape the diffuser 106 by tensioning the diffuser 106, and positioning of the portions of the diffuser 106 within the channels 116, 137, respectively, may ensure that the diffuser 106 is held in place relative to the rails 110A-B and the support member 120. In some embodiments, and as illustrated in FIGS. 1 and 2, the diffuser 106 is held in place relative to the rails 110A-B and the support member 120 such that the diffuser 106 is angled (e.g., extending upwards from the support member 120 towards the rails 110A-B). In such embodiments, the angled diffuser 106 may provide an improved light distribution such as but not limited to downlighting with a Lambertian light distribution.

The reflector 108 generally extends above the optics assembly 104 when the light fixture 100 is in the expanded configuration and is configured to reflect light emitted by the light sources 122 back through the diffuser 106. Similar to the diffuser 106, the reflector 108 of the light fixture 100 may be formed of a rigid material or may be constructed from various types of pliable materials such as but not limited to fabrics, non-fabric constructions, plastics, papers, etc. as desired. In some non-limiting embodiments, the reflector 108 is formed of a fabric material. In certain embodiments, the reflector 108 is attached to the diffuser 106 via various techniques or mechanisms as desired. In some embodiments, and referring to FIG. 6, the reflector 108 is sewn to the diffuser 106 and a seam 171 is formed. Optionally, the seam 171 is positioned within the channel 116, and the retention rod 119 may be inserted into a pocket formed proximate to the seam 171.

The reflector 108 may allow for the light fixture 100 to be moved between the expanded configuration and the collapsed configuration while the reflector 108 is connected to the rails 110A-B. In various embodiments, a fabric of the reflector 108 is different from the fabric of the diffuser 106. As a non-limiting example, the fabric of the reflector 108 may have a lower light transmissivity and a higher light reflectivity compared to the fabric of the diffuser 106. In one non-limiting example, the fabric material forming the reflector 108 may have a reflectivity of at least 70%, such as at least 80%, such as at least 90%; however, in other embodiments the reflector 108 may have other reflectivity values as desired. The fiber density of fabrics impacts these properties, and thus fabrics may be selected depending on the desired balance of reflectivity and transmissivity desired. Non-limiting examples of fabric suitable to form the reflector 108 may include polyethylene, linen, cotton, polyvinylchloride, polyethylene terephthalate, etc. In some non-limiting examples, the fabric of the reflector 108 is formed of a polyethylene fabric, such as polyethylene fabric sold under the trade name Tyvek® by DuPont. Such fabric is efficient in that little light is absorbed by the fabric itself. Rather, the fabric permits some light to pass through it, while reflecting other of the light. In other embodiments, the fabric of the reflector 108 may be the same as the fabric of the diffuser 106. As a non-limiting example, both the diffuser 106 and the reflector 108 may be formed from a polypropylene fabric. Similar to the diffuser 106, in some embodiments, the reflector 108 may be constructed from recycled materials.

Referring to FIG. 4, in some embodiments, the reflector 108 includes a patterned region 136 with a plurality of perforations 134 such that some light emitted from the light sources 122 may pass directly through the reflector 108 without impinging on the reflector 108. A non-patterned region 138 may, but does not have to, surround the patterned region 136 and is entirely or substantially devoid of perforations 134. Given that the perforations 134 can render the fabric structurally weaker, it may be desirable to have a non-patterned region 138 devoid of perforations where the reflector 108 connects to other parts of the light fixture 100 (e.g., the rails 110A-B). The perforations 134 may ensure and/or otherwise control the light emitted from light sources such that a desired light distribution is provided (e.g., such as but not limited to the batwing distribution discussed below) and the light distribution is not undesirably diffused away (e.g., by interacting with the material of reflector 108).

In embodiments with the plurality of perforations 134, the light passing through the reflector 108 may illuminate an area above the light fixture 100 (e.g., a ceiling) such that the light fixture 100 provides both uplighting and downlighting light distribution (e.g., light emitted from a light source of the light fixture 100 may be emitted in a first direction for direct lighting and a second direction for indirect lighting). Any number of perforations 134 may be provided, and the perforations 134 may have various shapes as desired, including but not limited to waves, diamonds, rectangles, triangles, hexagons, snowflakes, circles, combinations thereof, and/or other patterns as desired. Moreover, the perforations 134 may be provided in a regular pattern or a non-uniform/random distribution as desired.

In some embodiments, the patterned region 136 defines an openness percentage (i.e., the collective amount of open area in the patterned region 136 of the reflector 108, to control the light distribution through the reflector 108. As an example, an openness percentage of 0% would have no perforations, and an openness percentage of 100% would be completely open. In various embodiments, the openness percentage of the patterned region 136 may be from greater than 0% to about 60%, such as from about 5% to about 50%, such as from about 10% to 45%, such as from about 15% to 40%, such as from about 20% to about 35%, such as from about 20% to about 25%. In other embodiments, the openness percentage of the patterned region 136 may be controlled to be other percentages as desired and based on a desired percentage of light that is to be distributed as downlighting (e.g., through the diffuser 106) and a desired percentage of light that is to be distributed as uplighting (e.g., through the reflector 108). A ratio between the amount of uplighting and the amount of downlighting may be various ratios as desired. In some non-limiting examples, at least 50% of the emitted light may pass through the reflector 108 so as to be provided as indirect up lighting. In certain non-limiting examples, from about 30% to about 70% of light from the light fixture 100 may be uplighting, and from about 30% to about 70% of the light from the light fixture 100 may be downlighting. In certain non-limiting examples, from about 50% to about 70% of light from the light fixture 100 may be uplighting, and from about 30% to about 50% of the light from the light fixture 100 may be downlighting.

In certain embodiments, the perforations 134 of the patterned region 136 are controlled such that an openness factor, or a variation in openness, is substantially consistent (e.g., within a threshold tolerance) as measured along both a length and a width of the patterned region 136. In such embodiments, the consistent openness factor may provide more uniform illumination on the ceiling above the light fixture, devoid of artifacts. As an example, a non-uniform openness factor may create undesirable shadowing or other artifacts on the ceiling due to the uneven distribution of light through the reflector 108 (e.g., some areas may allow for more light through compared to other areas, resulting in artifacts). The consistent openness factor may therefore provide a more uniform and consistent light distribution.

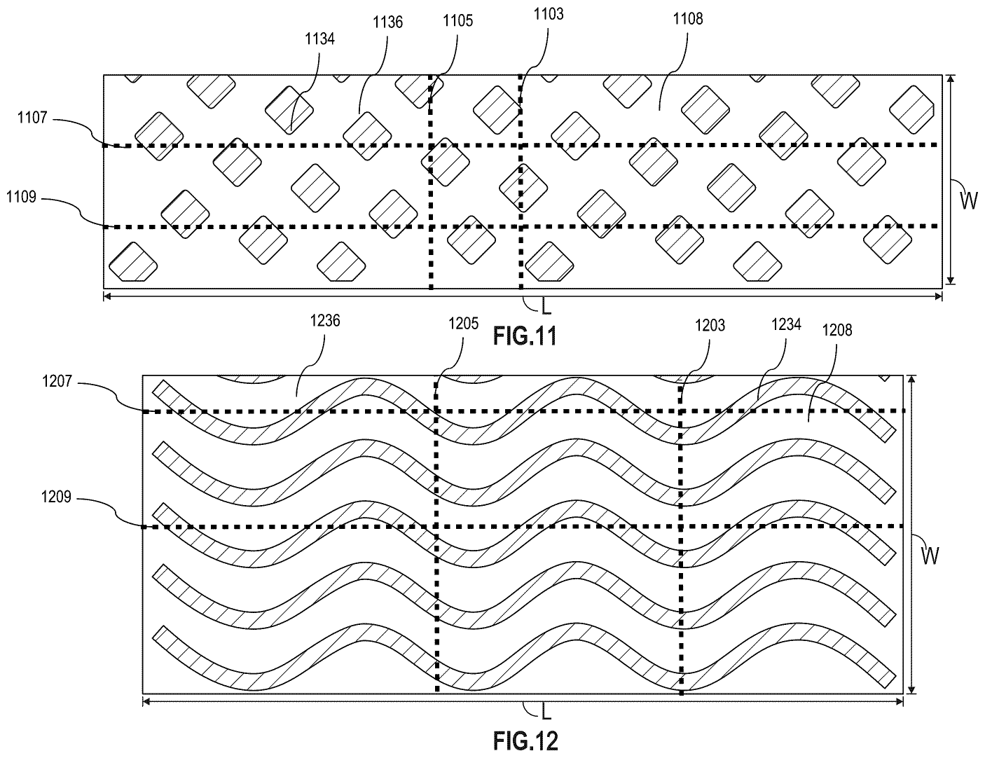

As an example, FIG. 11 illustrates a patterned region 1136 of a reflector 1108 with a plurality of perforations 1134 and having a length L and a width W. In this embodiment, along the length L, any given openness percentage measured in a direction perpendicular to the length L may be consistent, and along the width W, any given openness percentage measured in a direction perpendicular to the width W may be consistent. In FIG. 11, lines 1103 and 1105 are two examples of measurement lines for openness percentage measured in the direction perpendicular to the length L, and in various embodiments, the openness percentage measured along line 1103 is within a threshold tolerance of the openness percentage measured along line 1105. In other words, the percentage of the fabric along lines 1103 and 1105 that is open (by virtue of the perforations 1134) is the same or approximately the same, and the percentage of the fabric along lines 1103 and 1105 that is closed (by virtue of being devoid of perforations 1134) is the same or approximately the same. Similarly, lines 1107 and 1109 are two examples of measurement lines for openness percentage measured in the direction perpendicular to the width W, and in various embodiments, the openness percentage measured along line 1107 is the same or approximately the same (within a threshold tolerance) as the openness percentage measured along line 1109. In some embodiments, the perforations 1134 are positioned such that a substantially consistent degree of openness exists across a dimension of the reflector 108, regardless of where the measurement lines are taken across that dimension.

FIG. 12 illustrates another example of a patterned region 1236 of a reflector 1208 with a plurality of perforations 1234. In FIG. 12, lines 1203 and 1205 are two examples of measurement lines for openness percentage measured in the direction perpendicular to the length L, and in various embodiments, the openness percentage measured along line 1203 is within a threshold tolerance of the openness percentage measured along line 1205. Similarly, lines 1207 and 1209 are two examples of measurement lines for openness percentage measured in the direction perpendicular to the width W, and in various embodiments, the openness percentage measured along line 1207 is within a threshold tolerance of the openness percentage measured along line 1209.

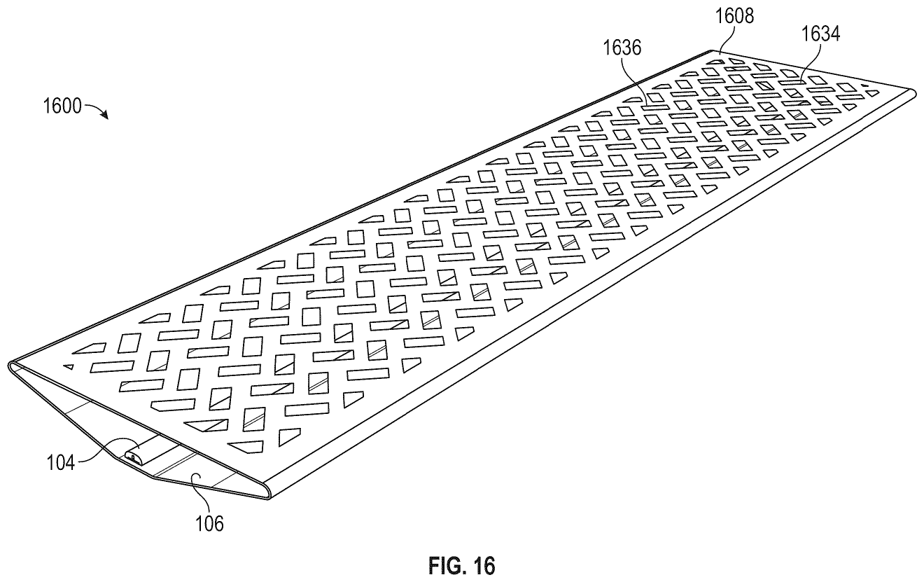

FIG. 16 illustrates another example of a light fixture 1600 according to embodiments. The light fixture 1600 is substantially similar to the light fixture 100 except that a reflector 1608 of the light fixture 1600 includes a patterned region 1636 having a plurality of perforations 1634 forming a herringbone pattern. Again, however, the perforations 1634 are positioned such that a substantially consistent degree of openness exists across a dimension of the reflector 1608, regardless of where the measurement lines are taken across that dimension.

FIGS. 13A-D illustrate exemplary steps for assembling a light fixture 1300 according to various embodiments. The light fixture 1300 is substantially similar to the light fixture 100 except that a pattern of perforations 1334 in the reflector 108 is different and the supports 112 are internal rods that slide along the length of the rails 110A-B to permit collapse and expansion.

As illustrated in FIG. 13A, the light fixture 1300 may be initially provided in the collapsed configuration in which the rails 110A-B are provided in close proximity to each other, optionally in contact with each other. In the collapsed configuration illustrated in FIG. 13A, the diffuser 106 and the reflector 108 optionally are rolled around the rails 110A-B, which may provide a compact shipping profile.

In FIG. 13B, while the rails 110A-B are still in the collapsed configuration, the diffuser 106 and the reflector 108 may be unrolled from the rails 110A-B such that the optics assembly 104 and the diffuser 106 are provided below the rails 110A-B and the reflector 108 is provided above the rails 110A-B.

In FIG. 13C, the rails 110A-B are illustrated at an intermediate configuration between the collapsed configuration and the expanded configuration. Movement from the collapsed configuration to the intermediate configuration of FIG. 13C may be achieved by spacing the rails 110A-B apart using supports 112.

In FIG. 13D, the light fixture 1300 is illustrated in the expanded configuration in which the rails 110A-B are at a maximum spaced apart position. Rail end caps 113 may be positioned on the light fixture 1300 and, along with supports 112, assist in holding the rails 110A-B in the desired relative position. In the expanded configuration, the diffuser 106 and/or the reflector 108 may be in tension, and the optics assembly 104 may help shape the diffuser 106.

FIG. 15 illustrates another example of a light fixture 1500 according to embodiments and in the collapsed configuration. As illustrated in FIG. 15, in the collapsed configuration, the light fixture 1500 assumes a flattened configuration whereby the optics assembly 104 is proximate to the reflector 108 to vertically collapse the fixture, but the rails 110A-B (not visible in FIG. 15) remain spaced from each other such that the fixture is not laterally collapsed.

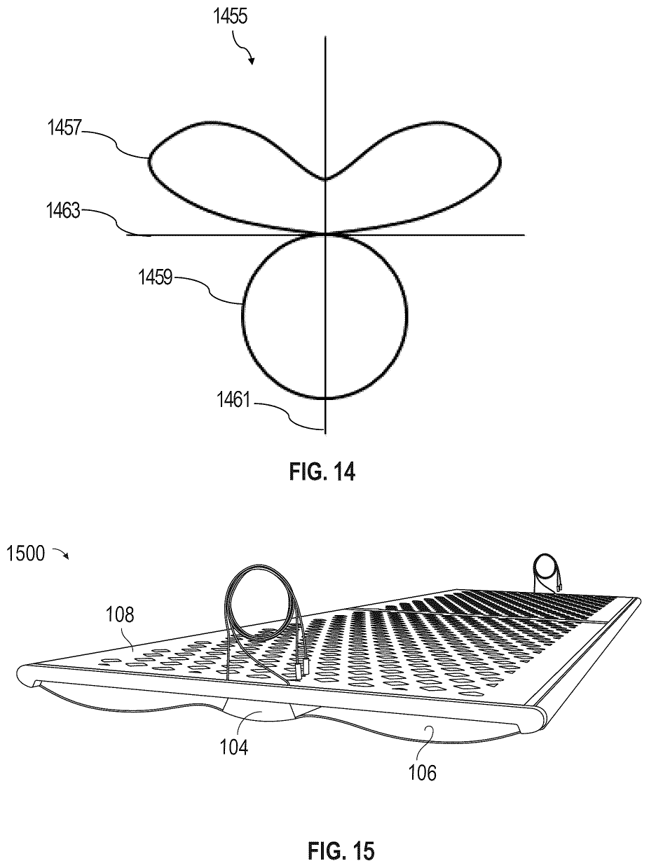

The light fixtures described herein may provide various light distributions or light patterns as desired. In certain embodiments the light fixtures described herein provide improved light distribution in at least two directions—light may be emitted upwardly in a first direction towards the reflector 108 and downwardly in a second direction towards the diffuser 106. FIG. 14 is a luminous intensity polar plot of an example of a light distribution 1455 from a light fixture according to embodiments, with the position of the light fixture represented by the intersection of the axes 1461, 1463. As illustrated in FIG. 14, the light distribution 1455 may include upwardly-emitted light 1457 emitted within the light fixture in a first direction towards a reflector of the light fixture (e.g., away from the optics assembly), and some of the light 1457 passes through the reflector. Light 1459 is also emitted in a second direction away from the reflector and through the diffuser. In other words, light emitted by the light fixture is directed away from the reflector regardless of whether the light is uplight or downlight. In various embodiments, the downwardly-emitted light 1459 may have a Lambertian distribution. The upwardly-emitted light 1457 is a “batwing” distribution directed toward a ceiling, which may produce greater uniformity of illuminance on the ceiling, thereby providing a better lit environment. The batwing distribution may also allow for the increased spacing between light fixtures while maintaining good ceiling uniformity. In certain embodiments, the batwing distribution is created by the lens 124, and the perforations on the reflector may ensure and/or otherwise control the light 1455 such that the batwing distribution is not undesirably diffused away (e.g., by interacting with the material of reflector). The batwing distribution may more evenly illuminate an underside of the reflector, which in turn may more evenly illuminate the diffuser via reflection off the non-perforated portion of the reflector. Other uplight and downlight distribution patterns may be used as desired.

The various aspects, embodiments, implementations or features of the described embodiments can be used separately or in any combination. In particular, it should be appreciated that the various elements of concepts from the figures may be combined without departing from the spirit or scope of the invention.

The use of the terms “a” and “an” and “the” and similar referents in the context of describing the invention (especially in the context of the following claims) are to be construed to cover both the singular and the plural, unless otherwise indicated herein or clearly contradicted by context. Directional references such as “up,” “down,” “top,” “bottom,” “left,” “right,” “front,” and “back,” among others, are intended to refer to the orientation as illustrated and described in the figure (or figures) to which the components and directions are referencing. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, the nearness of completion will be so as to have the same overall result as if absolute and total completion were obtained.

Preferred embodiments of this invention are described herein, including the best mode known to the inventors for carrying out the invention. The invention is susceptible to various modifications and alternative constructions, and certain shown exemplary embodiments thereof are shown in the drawings and have been described above in detail. Variations of those preferred embodiments, within the spirit of the present invention, may become apparent to those of ordinary skill in the art upon reading the foregoing description. The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

That which is claimed:

1. A light fixture comprising:
an optics assembly comprising at least one light source configured to emit light in a first direction;
a frame assembly;
a reflector; and
a diffuser formed from a pliable material,
wherein the frame assembly is adapted to support the reflector and the diffuser relative to the optics assembly such that the reflector is adapted (i) to permit at least some of the emitted light to exit the fixture in the first direction through the reflector and (ii) to reflect other of the emitted light in a second direction toward the diffuser.

2. The light fixture of claim 1, wherein the reflector is formed of a pliable material.

3. The light fixture of claim 1, wherein the pliable material is a fabric.

4. The light fixture of claim 1, wherein the light fixture is adapted to be moved between a collapsed configuration and an expanded configuration, wherein, in the expanded configuration, the diffuser is spaced from the reflector a distance greater than when the light fixture is in the collapsed configuration.

5. The light fixture of claim 4, wherein, in the collapsed configuration, the diffuser and the reflector are adapted to be partially wrapped around the optics assembly.

6. The light fixture of claim 4, wherein:
the frame assembly comprises a first rail and a second rail,
the reflector and the diffuser are each supported by the first rail and the second rail, and
in the collapsed configuration, the first and second rails are spaced a distance that is smaller than in the expanded configuration.

7. The light fixture of claim 1, wherein the second direction is substantially opposite the first direction.

8. The light fixture of claim 1, wherein a plurality of perforations are defined within the reflector to permit the at least some of the emitted light to directly exit the fixture in the first direction.

9. The light fixture of claim 1, wherein the diffuser is directly attached to the reflector.

10. The light fixture of claim 1, wherein the reflector extends above the diffuser.

11. The light fixture of claim 1, wherein the optics assembly is indirectly connected to the frame assembly via the diffuser.

12. A collapsible light fixture comprising:
a frame assembly;
a reflector formed of a pliable reflector material and attached to the frame assembly; and
a diffuser formed of a pliable diffuser material and supported by the frame assembly,
wherein the diffuser is adapted to be moved between an expanded configuration and a collapsed configuration relative to the reflector and while the diffuser is attached to the frame assembly.

13. The collapsible light fixture of claim 12, wherein the pliable reflector material is a first fabric and wherein the pliable diffuser material is a second fabric different from the first fabric.

14. The collapsible light fixture of claim 12, further comprising at least one light source supported below the reflector when the diffuser is in the expanded position.

15. A light fixture comprising:
a frame assembly;
a light source; and
a reflector supported by the frame assembly to directly receive and reflect light emitted by the light source, wherein the reflector comprises a patterned region comprising a length, a width, and a plurality of perforations, wherein the perforations define a first percent openness along a first axis perpendicular to the width and a second percent openness along a second axis offset from the first axis and perpendicular to the width, and that the first percent openness is substantially equal to the second percent openness regardless of a location of the first and second axes along the width of the patterned region.

16. The light fixture of claim 16, wherein the perforations define a third percent openness along a third axis perpendicular to the length and a fourth percent openness along a fourth axis offset from the fourth axis and perpendicular to the length, and that the third percent openness is substantially equal to the fourth percent openness regardless of a location of the third and fourth axes along the length of the patterned region.

17. The light fixture of claim 15, wherein the reflector is formed of a pliable material, and wherein the light fixture further comprises a diffuser formed of a pliable material and supported by the frame assembly to diffuse the reflected light.

18. The light fixture of claim 15, wherein an overall openness percentage of the patterned region is from 20% to 60%.

19. The light fixture of claim 15, wherein the reflector further comprises a non-patterned region surrounding the patterned region.

20. The light fixture of claim 15, wherein the perforations are diamond-shaped.
